(19) United States
(12) Patent Application Publication
(10) Pub. No.: US 2010/0101343 A1
(43) Pub. Date: Apr. 29, 2010

(54) SPINDLE DRIVING MECHANISM FOR MACHINE TOOL

(76) Inventors: Takeki Shirai, Shinagawa-ku (JP); Tomozumi Murata, Shinagawa-ku (JP)

Correspondence Address: SUGHRUE MION, PLLC, 2100 PENNSYLVANIA AVENUE, N.W., SUITE 800, WASHINGTON, DC, 20037, US

(21) Appl. No.: 12/593,888

(22) PCT Filed: Mar. 12, 2008
(86) PCT No.: PCT/JP2008/054465

§ 371 Date: Sep. 29, 2009

(30) Foreign Application Priority Data
Mar. 30, 2007 (JP) 2007-095498

(51) Int. Cl. B23Q 5/40; F16H 25/20; B23Q 5/10; H02K 7/06

(52) U.S. Cl. 74/89.34

(57) ABSTRACT

A spindle driving mechanism 5 for a machine tool includes a screw shaft 11 formed with a spiral thread groove 11a in the outer peripheral surface thereof; a ball screw nut 12 that is provided with a spiral nut groove corresponding to the thread groove 11a in the inner surface thereof, and that is configured so as to perform reciprocating motion in the axis direction of the screw shaft 11 with the rotational motion of the screw shaft 11 around the axis; a hollow motor 21 including a cylindrical inner rotor 22 fixedly provided on the outer peripheral surface of the ball screw nut 12 to serve as a field flux producing source, and a cylindrical outer stator 23 for generating a rotating magnetic field for giving a rotational driving force to the inner rotor 22; a cylindrical casing 31 on one end side of which the outer stator 23 is fixedly provided and on the other end side of which a spindle 51 for the machine tool is fixedly provided; and an outer cylinder 41 for guiding the reciprocating motion of the casing 31 in the axis direction. By this configuration, an improved spindle driving mechanism used for a machine tool can be obtained.

### TECHNICAL FIELD

The present invention relates to a spindle driving mechanism for a machine tool. More particularly, it relates to an improvement of a spindle driving mechanism used for a machine tool whose mechanism is disposed, for example, on a bed and is provided with a spindle head for movably supporting a spindle.

### BACKGROUND ART

Conventionally, there has been known a machine tool including a bed, a table disposed on the bed to place a workpiece thereon, a spindle the axis of which is arranged in the horizontal direction and which is provided so as to be rotatable around the axis to hold a tool, and a feeding drive for moving the table and the spindle relatively in the orthogonal three-axis directions (for example, refer to Patent Document 1).

For example, the conventional machine tool described in Patent Document 1 specifically includes a bed having a base and two side walls erected on both right and left sides of the base; a first slide provided so as to be movable in the vertical direction (Y-axis direction), which consists of a rectangular and frame-like member in which the longitudinal side part thereof is provided in the vertical direction and the transverse side part thereof is provided in the right-and-left direction, and in which both end parts thereof in the right-and-left direction are supported on the rear faces of the side walls; a second slide having a through hole penetrating in the front-and-rear direction, which slide is disposed in the frame of the first slide and is provided so as to be movable in the right-and-left direction (the X-axis direction); a spindle head which is disposed in the through hole of the second slide, and is provided so as to be movable in the front-and-rear direction (the Z-axis direction); a spindle supported by the spindle head so as to be rotatable around the axis parallel with the front-and-rear direction to hold a tool; and a table disposed on the bed to place a workpiece thereon.

Patent Document 1: Japanese Patent Laid-Open No. 2002-137128

### DISCLOSURE OF THE INVENTION

### Problems to be Solved by the Invention

In the technical field of a machine tool of this type, there has been a demand for increasing the motion accuracy of the spindle head provided so as to be movable in the front-and-rear direction (the Z-axis direction). In the conventional machine tool, however, since the spindle head moves in the through hole while making slide contact as described above, the conventional machine tool having such a slide contact part has a structural limit to the increase in motion accuracy.

Also, the conventional machine tool has a structural case in that since the weight of the spindle head moving in the front-and-rear direction (the Z-axis direction) is heavy, a force is applied in the deflection direction when the spindle head projects in the forward direction, so that it is difficult to ensure a degree of straight advance. In the conventional machine tool, however, a technique for increasing the degree of straight advance has not been proposed.

Furthermore, from the viewpoint of increasing the above-described motion accuracy and degree of straight advance, there has also been a demand for obtaining a spindle head that is more compact and lighter in weight.

The present invention has been made in view of the presence of the above-described cases, and accordingly an object thereof is to provide a technique capable of increasing the motion accuracy and the degree of straight advance of a spindle driving mechanism used for a machine tool, which mechanism is provided with a spindle head moving in the front-and-rear direction (the Z-axis direction).

### Means for Solving the Problems

A spindle driving mechanism for a machine tool in accordance with the present invention includes a screw shaft formed with a spiral thread groove in the outer peripheral surface thereof and fixedly provided so as to be non-rotatable; a ball screw nut that is provided with a spiral nut groove corresponding to the thread groove in the inner surface thereof and provided with a plurality of rolling elements rollably arranged in a loaded rolling element rolling path formed by the thread groove and the nut groove, and which is configured so as to perform reciprocating motion in the axis direction of the screw shaft with the rotational motion of the screw shaft around the axis; a hollow motor including a cylindrical inner rotor fixedly provided on the outer peripheral surface of the ball screw nut to serve as a field flux producing source, and a cylindrical outer stator arranged so as to be opposed to the inner rotor with a predetermined gap being provided between the cylindrical outer stator and the outer peripheral surface of the inner rotor to generate a rotating magnetic field for giving a rotational driving force to the inner rotor; a cylindrical casing on one end side of which the outer stator is fixedly provided and on the other end side of which a spindle for the machine tool is fixedly provided; and an outer cylinder provided on the casing via a plurality of rolling elements rollably arranged in a linear rolling element rolling groove formed in the outer peripheral surface of the casing to guide the reciprocating motion of the casing in the axis direction.

The spindle driving mechanism for a machine tool in accordance with the present invention is preferably configured so that when an imaginary axis centerline passing through the axis center of the screw shaft and an imaginary axis centerline passing through the axis center of a rotating shaft that the spindle has are assumed, the axis centerline of the screw shaft and the axis centerline of the rotating shaft that the spindle has are configured so as to be superposed on each other.

Also, in the spindle driving mechanism for a machine tool in accordance with the present invention, the outer cylinder can be provided in plural numbers for the casing.

Further, the spindle driving mechanism for a machine tool in accordance with the present invention can be configured so that at least two outer cylinders are provided for the casing, and a first outer cylinder arranged on the spindle fixing side of the casing has an axial length that is equal to or longer than the axial length of a second outer cylinder arranged on the outer stator fixing side of the casing.

Still further, in the spindle driving mechanism for a machine tool in accordance with the present invention, a seal member can be provided between the casing and the outer cylinder.

### EFFECTS OF THE INVENTION

According to the present invention, there can be provided a technique capable of increasing the motion accuracy and the degree of straight advance of a spindle head moving in the front-and-rear direction (the Z-axis direction) in a spindle driving mechanism used for a machine tool, which mechanism is disposed, for example, on a bed and is provided with the spindle head for movably supporting a spindle. Also, according to the present invention, a spindle driving mechanism for realizing the spindle head for a machine tool, which spindle head is more compact and lighter in weight than the conventional art, can be obtained.

### BRIEF DESCRIPTION OF THE DRAWINGS

FIG. 1 is a partially longitudinal sectional side view of a spindle driving mechanism for a machine tool in accordance with an embodiment of the present invention.

FIG. 2 is a longitudinal sectional side view for explaining a specific construction of a screw shaft and a ball screw nut in accordance with an embodiment of the present invention.

FIG. 3 is explanatory views for explaining the configuration of a guide mechanism section in accordance with an embodiment of the present invention. In particular, FIG. 3(a) is a longitudinal sectional front view of the guide mechanism section, and FIG. 3(b) is a partially longitudinal sectional side view of the guide mechanism section.

FIG. 4 is a side view showing an essential portion of a spindle driving mechanism for a machine tool in accordance with another embodiment of the present invention.

FIG. 5 is a schematic perspective view showing a state in which the spindle driving mechanism for a machine tool in accordance with another embodiment of the present invention shown in FIG. 4 is disposed on a machine tool.

### REFERENCE NUMERALS

5 . . . spindle driving mechanism for a machine tool, 11 . . . screw shaft, 11a . . . thread groove, 11b . . . loaded rolling element rolling path, 12 . . . ball screw nut, 12a . . . nut groove, 12b . . . return path, 12c . . . endless circulation passage, 13 . . . ball, 14 . . . fixing arm, 15 . . . ball screw mechanism section, 21 . . . hollow motor, 22 . . . inner rotor, 23 . . . outer stator, 31 . . . casing, 31a . . . rolling element rolling groove, 32 . . . ball, 35 . . . guide mechanism section, 41 . . . outer cylinder, 41a . . . loaded rolling element rolling groove, 41b . . . rolling element return path, 51 . . . spindle, 61 . . . first outer cylinder, 62 . . . second outer cylinder, 101 . . . bed, 103 . . . saddle, α . . . imaginary axis centerline passing through the axis center of screw shaft, β . . . imaginary axis centerline passing through the axis center of rotating shaft of spindle.

### MODE FOR CARRYING OUT THE INVENTION

Preferred embodiments for carrying out the present invention will now be described with reference to the accompanying drawings. The embodiments described below do not restrict the invention described in claims, and all combinations of the features described in the embodiments are not necessarily essential to means for solution of the invention.

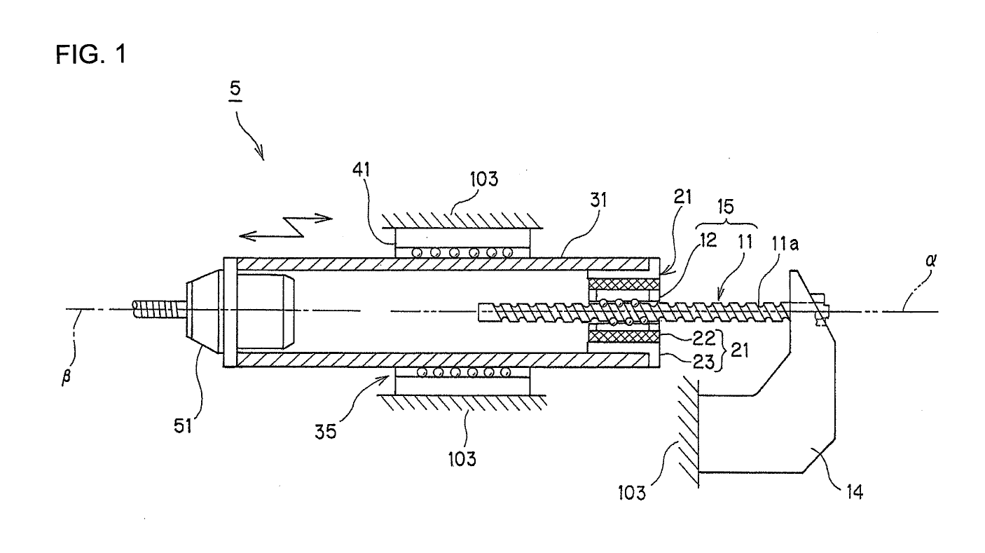

FIG. 1 is a partially longitudinal sectional side view of a spindle driving mechanism 5 for a machine tool in accordance with an embodiment. The spindle driving mechanism 5 for a machine tool in accordance with this embodiment is provided with the spindle head explained in the conventional art. The detailed explanation of other members constituting the machine tool is omitted for convenience of explanation.

The spindle driving mechanism 5 for a machine tool in accordance with this embodiment includes a ball screw mechanism section 15 formed by a screw shaft 11 and a ball screw nut 12, a hollow motor 21 serving as a driving source for this mechanism, a guide mechanism section 35 formed by a casing 31 and an outer cylinder 41, and a spindle 51 that performs work for the outside.

The screw shaft 11 is a member fixed to a fixing arm 14 provided on a saddle 103, and is configured in a non-rotatable state. In the outer peripheral surface of the screw shaft 11, a spiral thread groove 11a is formed. The screw shaft 11 forms the ball screw mechanism section 15 in cooperation with the ball screw nut 12.

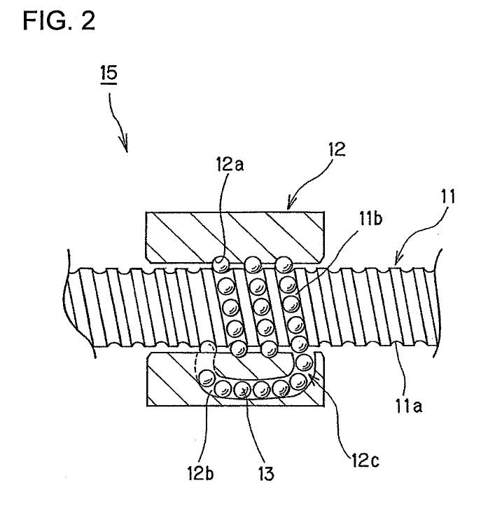

The specific construction of the screw shaft 11 and the ball screw nut 12 constituting the ball screw mechanism section 15 is explained with reference to FIG. 2. FIG. 2 is a longitudinal sectional side view for explaining the specific construction of the screw shaft 11 and a ball screw nut 12 in accordance with this embodiment, and illustrates the end cap type ball screw mechanism section 15.

As described above, the screw shaft 11 is provided with the spiral thread groove 11a in the outer peripheral surface thereof. On the other hand, the ball screw nut 12 is provided with a spiral nut groove 12a, which corresponds to the thread groove 11a of the screw shaft 11, in the inner peripheral surface thereof. By arranging the thread groove 11a and the nut groove 12a opposedly, a loaded rolling element rolling path 11b spirally surrounding the screw shaft 11 is formed. Further, both terminal parts of the loaded rolling element rolling path 11b spirally surrounding the screw shaft 11 are connected to each other by a return path 12b provided in the ball screw nut 12, and an endless circulation passage 12c is formed by the loaded rolling element rolling path 11b and the return path 12b.

In the endless circulation passage 12c, a plurality of balls 13 serving as rolling elements are arranged in a rollable state, by which engagement of the ball screw nut 12 with the screw shaft 11 via the balls 13 is realized. Since the screw shaft 11 is non-rotatably fixed to the fixing arm 14 provided on the saddle 103, by the rotating motion of the ball screw nut 12 around the axis of the screw shaft 11, the reciprocating linear motion of the ball screw nut 12 in the axis direction can be performed.

The hollow motor 21 serving as a driving source for this mechanism includes a cylindrical inner rotor 22 serving as a field flux producing source that is fixedly provided on the outer peripheral surface of the ball screw nut 12, and a cylindrical outer stator 23 that is arranged so as to be opposed to the inner rotor 22 with a predetermined gap being provided between the cylindrical outer stator 23 and the outer peripheral surface of the inner rotor 22 to generate a rotating magnetic field for giving a rotational driving force to the inner rotor 22.

Although not shown in FIG. 1 for simplification, the inner rotor 22 of this embodiment includes a rotor magnet in which N poles and S poles are magnetized alternately in the circumferential form, a cylindrical inner frame for fixing the rotor magnet, and a bearing for rotatably supporting the inner frame. On the other hand, the outer stator 23 of this embodiment includes a plurality of flat stator coils arranged so as to be opposed to the rotor magnet with a predetermined gap therebetween, a flexible printed board in which the stator coils are laid, and a cylindrical outer frame for fixing the stator coils and the flexible printed board to the bearing.

The inner frame of the inner rotor 22 is fixed to the outer peripheral surface of the ball screw nut 12, and the outer frame of the outer stator 23 is fixed to the casing 31, described later. Therefore, when the hollow motor 21 is driven, the ball screw nut 12 rotates with the rotational drive of the inner rotor 22, and thereby the reciprocating linear motion of the casing 31 along the axis direction of the screw shaft 11 is realized.

The casing 31 is a member formed into a substantially cylindrical shape. As described above, the outer stator 23 is fixedly provided on one end side of the casing 31, and on the other hand, the spindle 51 for the machine tool is fixedly provided on the other end side thereof. The interior of the casing 31 is hollow except that the outer stator 23 and the spindle 51 are provided, so that the security of stroke and the lightweight of the screw shaft 11 are realized at the same time. Regarding the material, shape (length, wall thickness, etc.), and the like of the casing 31, the optimal ones should be selected appropriately according to the application, specifications, and the like of the machine tool.

Also, the outer cylinder 41 is provided on the outer periphery side of the casing 31, and the guide mechanism section 35 is formed by the casing 31 and the outer cylinder 41. By the presence of the outer cylinder 41, steady reciprocating linear motion of the casing 31 along the axis direction of the screw shaft 11 is realized.

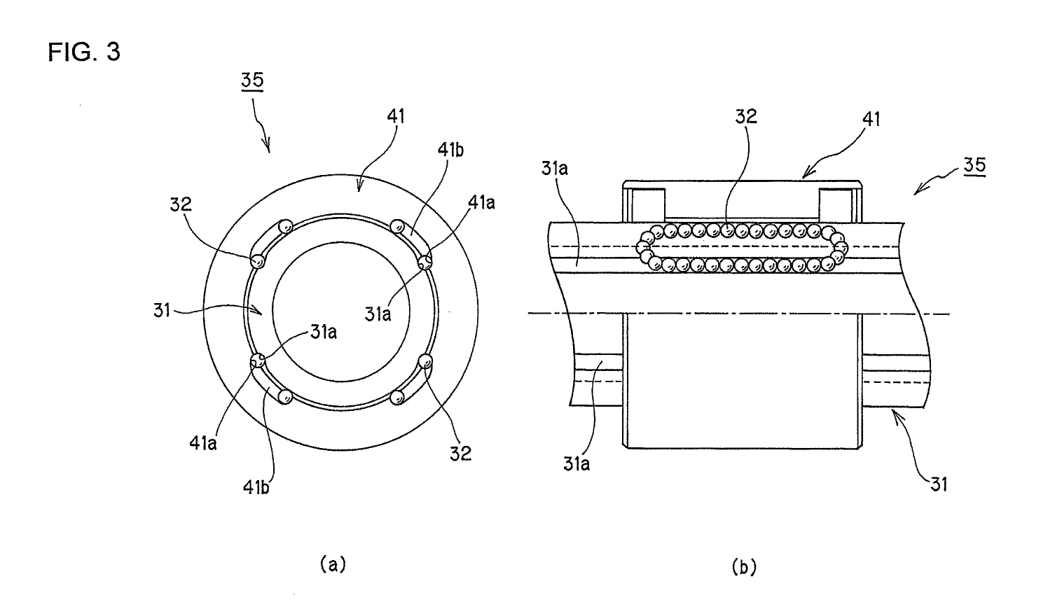

The detailed construction of the guide mechanism section 35 formed by the casing 31 and the outer cylinder 41 is explained with reference to FIG. 3. FIG. 3 is explanatory views for explaining the configuration of the guide mechanism section 35 in accordance with this embodiment. In particular, FIG. 3(a) shows the longitudinal sectional front of the guide mechanism section 35, and FIG. 3(b) shows the partially longitudinal sectional side of the guide mechanism section 35. In FIG. 3, the illustration of members other than the guide mechanism section 35 is omitted for convenience of explanation.

The casing 31 constituting the track member of the guide mechanism section 35 is provided with linear rolling element rolling grooves 31a in the outer peripheral surface thereof. Each of the rolling element rolling grooves 31a serving as a track for balls 32 receives moment of rotation in the circumferential direction of the casing 31, and regulates the movement direction of the casing 31 itself.

The outer cylinder 41 installed on the casing 31 functions as a guide member for the guide mechanism section 35, and is formed with loaded rolling element rolling grooves 41a, which correspond to the rolling element rolling grooves 31a, in the inner peripheral surface thereof. By the loaded rolling element rolling groove 41a formed on the outer cylinder 41 and the rolling element rolling groove 31a formed on the casing 31, a loaded rolling element rolling path is formed. Further, in the outer cylinder 41, rolling element return paths 41b are formed. Each of the rolling element return paths 41b is connected to both end parts of the loaded rolling element rolling path to scoop up and circulate the balls 32 released from the load in the loaded rolling element rolling path and to return the balls 32 into the loaded rolling element rolling path again. That is to say, the balls 32 are rollably arranged between the loaded rolling element rolling groove 41a of the outer cylinder 41 and the rolling element rolling groove 31a of the casing 31, and are arranged so as to circulate in an endless manner passing through the rolling element return paths 41b.

Since the guide mechanism section 35 of this embodiment has the above-described configuration, the casing 31 does not rotate in the circumferential direction, so that steady reciprocating linear motion of the casing 31 along the axis direction of the screw shaft 11 is realized.

As the spindle 51 disposed on the other end side of the casing 31, a publicly known spindle of any type, such as an aerostatic spindle capable of achieving high-speed rotation and high output, can be used. In particular, the aerostatic spindle has an advantage of being capable of being suitably used for high-speed milling and the like because it has a construction in which an inherent restrictor is used as a restrictor suitable for high-speed rotation, and an induction motor is mounted corresponding to high-speed rotation and high output.

The above is an explanation of the specific configuration of the spindle driving mechanism 5 for a machine tool of this embodiment. The spindle driving mechanism 5 for a machine tool of this embodiment realizes a spindle head movable in the front-and-rear direction (the Z-axis direction) with a compact structure while having equal or greater rigidity than the connectional because it has the ball screw mechanism section 15 and the guide mechanism section 35 capable of achieving stable guide accuracies using rolling elements with a compact structure.

Also, the guide accuracy of the spindle head is increased tremendously by the operation of the ball screw mechanism section 15 and the guide mechanism section 35. In particular, minute pulsation called waving can be kept to a fluctuation of, for example, 1.6 μm or less. Therefore, a guide accuracy incapable of having been achieved by the conventional spindle head involving sliding motion can be realized. The improvement in waving phenomenon achieves an effect of improving the degree of straight advance of spindle head.

Furthermore, in the spindle driving mechanism 5 for a machine tool of this embodiment, the screw shaft 11 can be stored in a compact manner by forming the casing 31 into a hollow cylindrical shape, and also a light weight is realized by the presence of the hollow part. Also, the presence of the hollow part of the casing 31 realizes rational compactness of the mechanism itself. Specifically, when an imaginary axis centerline a passing through the axis center of the screw shaft 11 and an imaginary axis centerline β passing through the axis center of a rotating shaft that the spindle 51 has are assumed, the axis centerline α of the screw shaft 11 and the axis centerline β of the rotating shaft that the spindle 51 has are configured so as to be superposed on each other. This configuration achieves an effect of integrating two complicated mechanisms, the ball screw mechanism section 15 and the guide mechanism section 35, in a compact manner. By using such a waste-less device configuration, seemingly contradictory issues of light weight and high rigidity can simultaneously be resolved for the first time.

Between the casing 31 and the outer cylinder 41 and between the screw shaft 11 and the ball screw nut 12, a seal member (not shown) is preferably installed to remove foreign matters intruding from the outside and to hold a lubricant therein. By installing the seal member, a stable and long-life spindle driving mechanism 5 for a machine tool can be obtained. Since the casing 31 of this embodiment has a cylindrical external shape, outstanding sealability can be exhibited when the seal member is installed. The shape of the casing 31 may be a tubular shape which has a hollow part and on which the outer cylinder 41 can be installed. Besides the cylindrical shape described in this embodiment, a polygonal tubular shape, an elliptical tubular shape, an elongated cylindrical shape, and the like can be used.

The above is a description of a preferred embodiment of the present invention. The technical scope of the present invention is not limited to the scope described in the above-described embodiment. The above-described embodiment can be changed or improved variously.

For example, in the above-described embodiment, the configuration in which one outer cylinder 41 is arranged for the casing 31 has been explained. However, the number of outer cylinders 41 installed on the casing 31 is not limited to one, and a plurality of outer cylinders 41 can be installed.

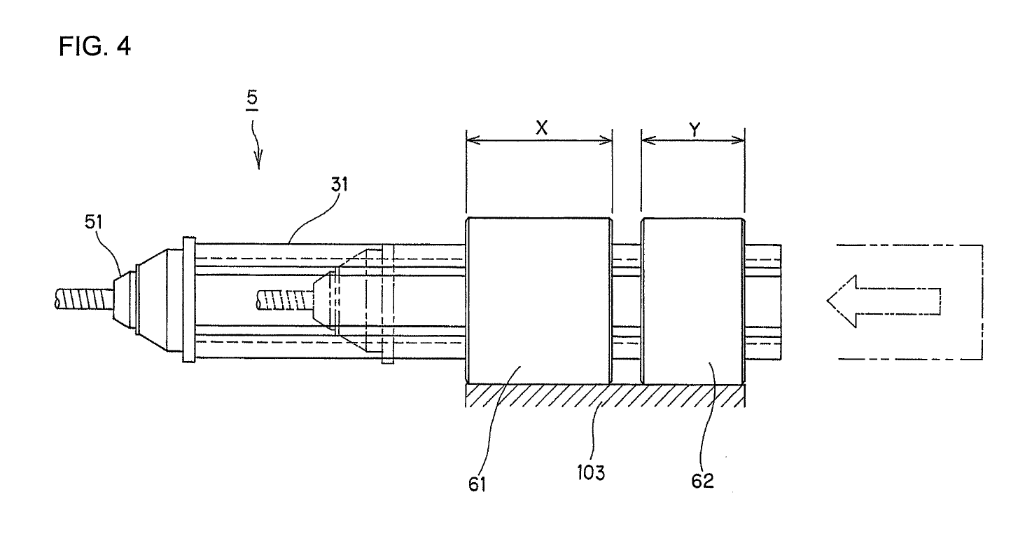

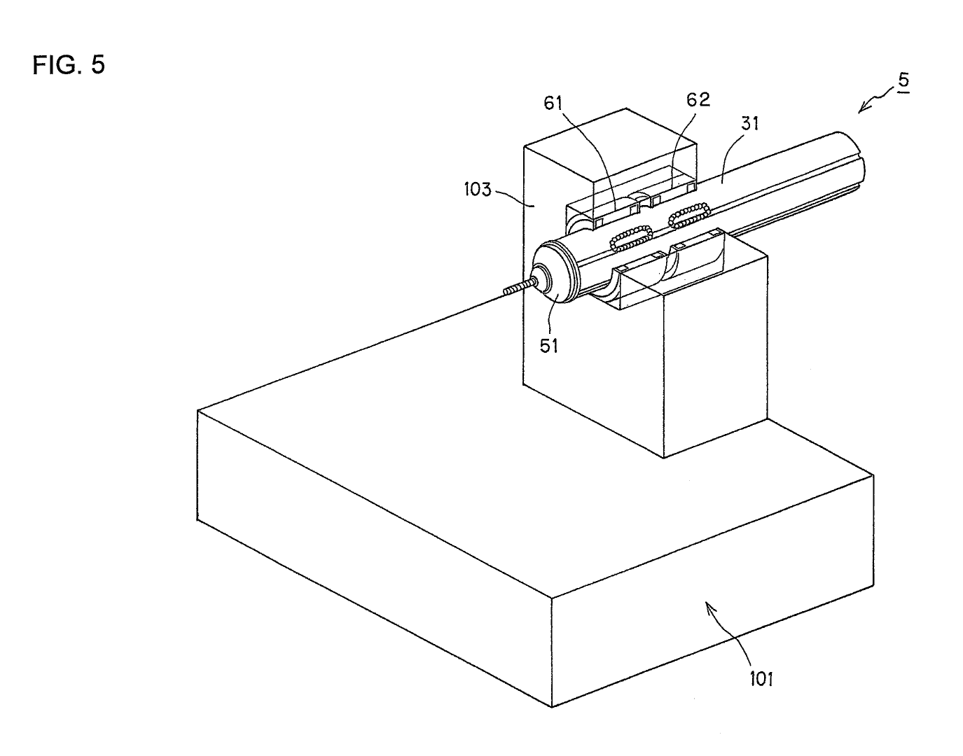

Another embodiment in which two outer cylinders are installed on the casing 31 is explained with reference to FIGS. 4 and 5. FIG. 4 is a side view showing an essential portion of a spindle driving mechanism for a machine tool in accordance with another embodiment of the present invention. Also, FIG. 5 is a schematic perspective view showing a state in which the spindle driving mechanism for a machine tool in accordance with another embodiment of the present invention shown in FIG. 4 is disposed on a machine tool. In FIGS. 4 and 5, the illustration of the screw shaft 11 and the like is omitted for convenience of explanation, and the same symbols are applied to members that are the same as or similar to the members explained already, and the explanation of these members is omitted.

In the spindle driving mechanism 5 for a machine tool in accordance with another embodiment shown in FIGS. 4 and 5, two outer cylinders 61 and 62 are installed on the casing 31. In the explanation below, an outer cylinder arranged on the spindle 51 fixing side of the casing 31 is called the first outer cylinder 61, and an outer cylinder arranged on the outer stator fixing side of the casing 31 is called the second outer cylinder 62.

An advantageous point of installing two outer cylinders of the first and second outer cylinders 61 and 62 is that the relative positional adjustment of the casing 31 can be made easily. That is to say, when the casing 31 projects, a deflection force acts due to the weight of the casing 31, which exerts an adverse influence on the degree of straight advance of the spindle head. Therefore, the installation angle of the casing 31 is adjusted by using the outer cylinders 61 and 62 divided into two, by which the degree of straight advance can be increased easily. Specifically, a height adjusting member, such as a shim, is inserted, for example, between the contact surfaces of the first outer cylinder 61 and the saddle 103 supporting the first outer cylinder 61, by which the installation angle of the casing 31 can be adjusted.

Also, for the first and second outer cylinders 61 and 62, outer cylinders simply having the same size can be applied. However, the configuration is also preferably made such that the first outer cylinder 61 has an axial length longer than that of the second outer cylinder 62 as shown in FIGS. 4 and 5. According to this configuration, the first outer cylinder 61 having a longer axial length is mainly subjected to torsional rigidity and a load such as the own weight and the working reaction, and the second outer cylinder 62 having a shorter axial length can be used to adjust the accuracy such as the degree of straight advance. By sharing the function of the two outer cylinders 61 and 62, more efficient device configuration can be adopted, so that compactness as the whole of mechanism is realized.

As the configuration condition of the two outer cylinders 61 and 62, when the axial length of the first outer cylinder 61 is taken as X and the axial length of the second outer cylinder 62 is taken as Y, for example, the configuration may be such that X=Y, or the configuration may be such that a formula of X>Y holds.

As the result of an earnest effort of the inventor, it has been confirmed that the configuration such that, for example, X≧1.5Y is preferable. In this case, regarding the number of balls 32 arranged in each of the outer cylinders, it is preferable that in the first outer cylinder 61, the balls 32 many as far as the space permits be arranged, and in the second outer cylinder 62, the balls 32 fewer than the balls 32 in the first outer cylinder 61 be arranged. The reason for increasing the number of balls in the first outer cylinder 61 is that the first outer cylinder 61 receives a higher load, and the reason for decreasing the number of balls in the second outer cylinder is that the second outer cylinder 62 mainly increases the motion accuracy and the degree of straight advance while the receipt of load is entrusted to the first outer cylinder 61. By using this configuration, the function can be shared efficiently between the two outer cylinders 61 and 62.

Needless to say, for the two outer cylinders 61 and 62 as well, a seal member is preferably installed between the outer cylinders 61 and 62 and the casing 31, and the stability and service life of mechanism are increased by the action of the seal member.

Further, in the above-described embodiment, the end cap type ball screw mechanism section 15 has been explained. However, the ball screw mechanism section to which the present invention can be applied is not limited to the end cap type one. A pipe type ball screw mechanism section using a return pipe or a deflector type ball screw mechanism section using a deflector can also be used.

Still further, in the above-described embodiment, the guide mechanism section 35 of a type such that the balls 32 circulate in an endless manner has been explained. However, a guide mechanism section of a type such that the balls 32 circulate finitely according to the operation range required by the spindle 51 may also be used.

Still further, in the spindle driving mechanism for a machine tool in accordance with the present invention, the cross-sectional shape and the number of endless circulation passages of the ball screw mechanism section 15 and the guide mechanism section 35 illustrated in the above-described embodiment can be changed appropriately according to the service environment, the service conditions, and the like.

Also, in the above-described embodiment, a so-called horizontal type spindle driving mechanism 5 for a machine tool in which the Z axis is set in the front-and-rear direction has been explained. However, the present invention can be applied to a vertical type machine tool in which the Z axis is set in the up-and-down direction.

Furthermore, for the spindle driving mechanism 5 for a machine tool in accordance with the above-described embodiment, the case where only the spindle driving mechanism 5 for a machine tool is disposed on the saddle 103 of the machine tool has been explained for simplification of explanation. However, the spindle driving mechanism for a machine tool in accordance with the present invention can also be disposed on a machine tool provided with a first slide and a second slide moving in the vertical direction (the Y-axis direction) and the right-and-left direction (the X-axis direction) or a multi-spindle machine tool provided with spindles of three or more axes. Also, the member on which the spindle driving mechanism for a machine tool is installed is not limited to the above-described saddle 103. The spindle driving mechanism for a machine tool in accordance with the present invention can be disposed on any member if the spindle driving mechanism can perform its operation.

It is apparent from claims that a mode in which the above-described changes and improvements are made can also be embraced in the technical scope of the present invention.

1. A spindle driving mechanism for a machine tool, comprising:
a screw shaft formed with a spiral thread groove in the outer peripheral surface thereof and fixedly provided so as to be non-rotatable;
a ball screw nut which is provided with a spiral nut groove corresponding to the thread groove in the inner surface thereof and provided with a plurality of rolling elements rollably arranged in a loaded rolling element rolling path formed by the thread groove and the nut groove, and which is configured so as to perform reciprocating motion in the axis direction of the screw shaft with the rotational motion of the screw shaft around the axis;
a hollow motor comprising a cylindrical inner rotor fixedly provided on the outer peripheral surface of the ball screw nut to serve as a field flux producing source, and a cylindrical outer stator arranged so as to be opposed to the inner rotor with a predetermined gap being provided between the cylindrical outer stator and the outer peripheral surface of the inner rotor to generate a rotating magnetic field for giving a rotational driving force to the inner rotor;
a cylindrical casing on one end side of which the outer stator is fixedly provided and on the other end side of which a spindle for the machine tool is fixedly provided; and
an outer cylinder provided on the casing via a plurality of rolling elements rollably arranged in a linear rolling element rolling groove formed in the outer peripheral surface of the casing to guide the reciprocating motion of the casing in the axis direction.

2. The spindle driving mechanism for a machine tool according to claim 1, characterized in that
when an imaginary axis centerline passing through the axis center of the screw shaft and an imaginary axis centerline passing through the axis center of a rotating shaft that the spindle has are assumed, the axis centerline of the screw shaft and the axis centerline of the rotating shaft that the spindle has are configured so as to be superposed on each other.

3. The spindle driving mechanism for a machine tool according to claim 1 or 2, characterized in that
the outer cylinder is provided in plural numbers for the casing.

4. The spindle driving mechanism for a machine tool according to claim 1 or 2, characterized in that
at least two outer cylinders are provided for the casing; and
a first outer cylinder arranged on the spindle fixing side of the casing has an axial length that is equal to or longer than the axial length of a second outer cylinder arranged on the outer stator fixing side of the casing.

5. The spindle driving mechanism for a machine tool according to any one of claims 1 to 4, characterized in that
a seal member is provided between the casing and the outer cylinder.
